(19) United States
(12) Patent Application Publication
(10) Pub. No.: US 2008/0020881 A1
(43) Pub. Date: Jan. 24, 2008

(54) Chain for driving a component

(75) Inventor: Joachim Sporrer, Erlangen (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/880,098

(22) Filed: Jul. 18, 2007

Related U.S. Application Data
(60) Provisional application No. 60/835,846, filed on Aug. 4, 2006.

(30) Foreign Application Priority Data
Jul. 21, 2006 (DE) 10 2006 033 732.8

(51) Int. Cl. F16G 13/02

(52) U.S. Cl. 474/206

(57) ABSTRACT

A chain for driving a component, in particular a motor vehicle component. The chain has a plurality of chain links that have a plurality of markings, at least two of the markings being different in shape and/or color. The markings can be applied to a link plate.

### BACKGROUND OF THE INVENTION

1. Field of the Invention

The present invention relates to a chain for driving a component, in particular a motor vehicle component, wherein the chain includes a plurality of chain links that have a plurality of markings.

2. Description of the Related Art

Drive chains serve as traction mechanism drives for various components, for example, in particular for components and systems in the automotive field. Preferably, the known chain can also be employed as a timing chain for a camshaft of a motor vehicle.

With such chains it is usual for chain links to be provided with markings, in order to place certain information on the chain links. Therefore, a plurality of identical markings are provided on one or more chain links. Due to the large number of like markings, the applied information is confusing on the known chains, so that the chains can be mistaken during manufacture or assembly, for example when closing the chains in the assembly line. In the case of a timing chain, for example, an additional marking for the control time setting is necessary. Clear identification of those markings and the ability to distinguish over the other markings is not readily possible with the known chain, due to the mistaken markings.

In consequence, an object of the present invention is to improve a chain of the type identified above in order to enable clear recognition and coordination of the various markings.

### SUMMARY OF THE INVENTION

In accordance with the present invention, the object is achieved by a chain for driving a component, in particular a motor vehicle component, and having a plurality of chain links that include a plurality of markings, at least two of the markings being different in shape and/or color.

In that way, a plurality of markings, even if provided side-by-side or on a plurality of chain links, for example, can be recognized clearly and distinguished from each other because of their difference in shape and/or color. Preferably, the markings can be provided on one or even more outer plates of the chain links.

The markings can be inscriptions, or the like, in a great variety of colors that portray and convey certain information. Thus, different items of information that are separate from and independent of each other can be identified clearly. For example, symbols, certain written characters, but also other elements, can also be used as markings.

As a result, absolute process reliability can be ensured when installing the chain, and even when fabricating it. Risk of confusion and unclear, inflexible conveying of information can be prevented with the chain in accordance with the invention, in contrast to the known chains.

It is especially advantageous if the link of the chain intended as the closing link bears at least one of the markings or inscriptions. That enables that significant location to be found in the simplest way, for example during installation of the chain.

As stated earlier, the markings can represent specific items of information. In accordance with a refinement of the invention, information provided can be manufacturer data, and/or fabrication data, and/or chain data, and/or timing control data of a timing chain, for example, for controlling a camshaft. For the manufacturer's data, a particular logo or a particular name, for example, or even customer data, can be provided on one or more chain links. With regard to the fabrication data, the date of manufacture or place of manufacture can be noted, for example. For the chain data, in particular the chain length as well as the number of links, can be noted as information on a chain link. Part or all of the information provided on the chain links can be encrypted.

In accordance with a further embodiment, the markings on the chain in accordance with the invention can be permanently or non-permanently applied markings, which are applied by means of appropriate inscription or marking devices. For example, if certain information is only useful for assembly, that information can also be removed from the chain in accordance with the invention after a certain time in the simplest manner.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic side view of one possible embodiment of a chain that runs around a plurality of gears, and

FIG. 2 is an enlarged side view of a chain link having a plurality of markings.

### DESCRIPTION OF THE PREFERRED EMBODIMENTS

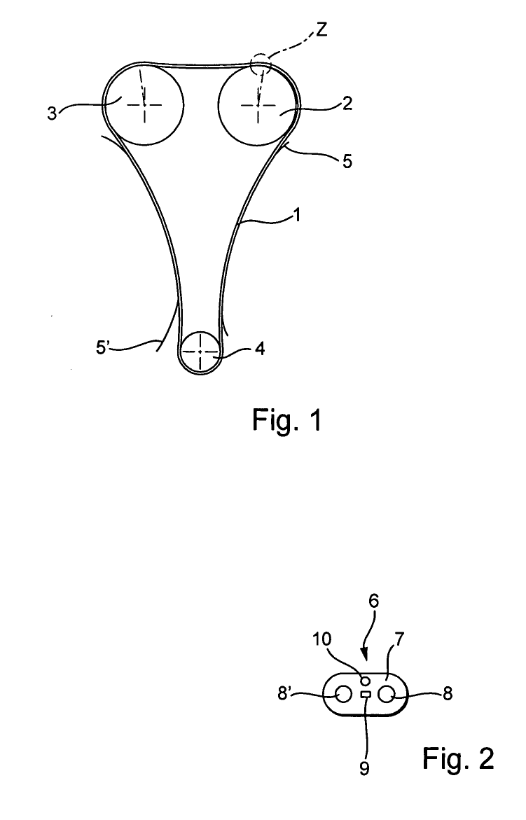

FIG. 1 shows a schematic side view of one possible embodiment of a chain 1 in accordance with the present invention. Chain 1 is shown in its closed condition and runs around three gears 2, 3, and 4. Chain 1 is in contact in certain regions with chain guides 5, 5′, which place chain 1 under a predetermined tension. Chain 1 in accordance with the invention is not limited to a particular type of design, nor to a particular area of application.

In the exemplary embodiment shown, chain 1 includes a plurality of chain links 6 (see FIG. 2) hingedly connected to each other. Each chain link is made up of a plurality of link plates extending approximately parallel to each other, which are movably joined together by way of pins 8, 8′. Only one outer plate 7 is shown in FIG. 2.

FIG. 2 shows in enlarged form, and by way of example, a chain link 6 identified as detail Z in FIG. 1. As an example, two markings 9, 10 are provided on chain link 6 to illustrate a variety of information types and location on the outer plate 7 of a chain link. The markings 9, 10 can preferably be centered on the surface of outer plate 7 of chain 1 in accordance with the invention. Marking 9 has an approximately square shape in the exemplary embodiment shown. Marking 10 on the other hand is of approximately circular design, so that markings 9, 10 are clearly distinguishable from each other.

The distinguishable markings offer the advantage that with one or more marked or inscribed chain links clear assignment of the information or clear recognition of the information is made possible.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A chain for driving a motor vehicle component and having a plurality of chain links, said chain comprising: chain links that include plural markings, wherein at least two markings (9, 10) differ in alt least one of shape and color.

2. A chain in accordance with claim 1, wherein the markings are provided on an outer plate of the chain links.

3. A chain in accordance with claim 1, wherein the markings are applied to a chain link that is designated as a closing link.

4. A chain in accordance with claim 1, wherein the markings include at least one of information about manufacturer data, information about fabrication data, information about chain data, and information about timing control settings for a timing chain.

5. A chain in accordance with claim 1, wherein permanently applied markings are provided.

6. A chain in accordance with claim 1, wherein non-permanently applied markings are provided.
